(19) United States
(12) Patent Application Publication
(10) Pub. No.: US 2008/0078084 A1
(43) Pub. Date: Apr. 3, 2008

(54) HYDRODYNAMIC BEARING ASSEMBLY AND METHOD OF MANUFACTURING THE SAME

(75) Inventors: Yoichi SEKII, Kyoto (JP); Hiroshi OGAWA, Kyoto (JP)

Correspondence Address: VOLENTINE & WHITT PLLC, ONE FREEDOM SQUARE, 11951 FREEDOM DRIVE SUITE 1260, RESTON, VA, 20190, US

(73) Assignee: NIDEC CORPORATION, Kyoto (JP)

(21) Appl. No.: 11/860,577

(22) Filed: Sep. 25, 2007

(30) Foreign Application Priority Data
Sep. 28, 2006 (JP) 2006-263841

(51) Int. Cl. B21K 1/00; G11B 17/00; H02K 21/12

(52) U.S. Cl. 29/898.02; 310/156.01; 360/97.01

(57) ABSTRACT

One or more of constructional members of a hydrodynamic bearing assembly are nickel-plated, and the members to be welded and fixed are arranged to abut on one another. The nickel plating is performed so as to form a plated layer of less than 10 μm in thickness between the members to be welded and fixed. An energy beam is applied at the joining portion of the members to be welded and fixed, to weld and fix these members.

### BACKGROUND OF THE INVENTION

1. Field of the Invention

The present invention generally relates to a hydrodynamic bearing assembly and a method of manufacturing the same.

2. Description of the Related Art

In spindle motors for use in disk drive devices such as hard disk drives for rotating data storage disks, it has become common to employ fluid dynamic bearings as bearing means for their adaptability to high rotational speeds.

Generally, the fluid dynamic bearing assembly has a configuration in which a shaft and a sleeve are rotatably held relative to each other. On the shaft and the sleeve, there are provided a radial bearing portion for supporting loads in the radial direction of the shaft or the sleeve, and a thrust bearing portion for supporting loads in the axial direction. A bearing surface provided on the sleeve and a bearing surface provided on the shaft face each other with a minute gap in between to define these bearing portions. Grooves for producing dynamic pressure are formed on at least one of the bearing surfaces of the sleeve and the shaft, and lubricant oil is filled in the minute gap between the bearing surfaces.

In such a hydrodynamic bearing assembly, the lubricant oil retained in the minute gap is compressed onto the dynamic pressure generating grooves along their groove pattern when, for example, the sleeve is rotated, so that pressure is locally increased in the lubricant oil. By utilizing this increased pressure, the radial bearing portion supports the load in the radial direction of the shaft, and the thrust bearing portion supports the load in the thrust direction of the shaft.

Disadvantageously, the lubricant oil may leak to the outside of the hydrodynamic bearing assembly, running through the surfaces of the shaft and/or the sleeve in the hydrodynamic bearing assembly. In order to prevent such leakage of the lubricant oil, there is proposed a method in which oil repellent treatment, such as application of an oil repellent agent, is performed on a portion where the minute gap retaining the lubricant oil communicates with the exterior of the bearing assembly to prevent leakage of the lubricant oil.

Oil repellent agents to be applied to the shaft and/or the sleeve are typically transparent and colorless, and so it is difficult to visually ascertain whether the oil repellent treatment has been properly effected during and after the oil repellent treatment. Therefore, inspection and ascertaining processes have to be incorporated individually in the working process in order to check whether the oil repellent film has been properly formed, which is time consuming and inevitably invites lowering of working efficiency.

In view of the above, Japanese Unexamined Patent Application Publication No. 2001-304263 discloses such a technique that carbon black is added in a transparent and colorless oil repellent agent, thereby enabling visual ascertainment of application of the oil repellent agent. There is also disclosed in Japanese Unexamined Patent Application Publication No. 2004-211851 a method for visually inspecting the applied condition of an oil repellent agent by adding a small amount of UV color former component in the transparent and colorless oil repellent agent, drying the applied oil repellent agent at an ambient temperature, and applying ultraviolet light beams thereto. According to this method, the member applied with the oil repellent agent is heated after the inspection of applied condition of the oil repellent agent, to evaporate the solvent dissolving the oil repellent agent and the UV color former component and thus to fix the oil repellent film on the surface of the member.

The use of the oil repellent agent on the hydrodynamic bearing assembly possibly causes generation of micro contaminations within the hydrodynamic bearing such that microparticles in the oil repellent film are released due to contact of the shaft and the sleeve at the start and the end of the rotation of the motor.

Hence, there is published a technique of preventing leakage of lubricant fluid from the joining part of constructional members by integrally fixing some of the constructional members of a hydrodynamic bearing assembly by welding (see, for example, Japanese Patent Nos. 3630736 and 3655492).

It is, however, not easy to laser-weld members made of aluminum or an aluminum alloy directly to each other to manufacture a hydrodynamic bearing assembly, because aluminum and aluminum alloys are highly reflective to converged energy beams (90% or more reflectivity at YAG (yttrium-aluminum-garnet) laser beam wavelength 1030 nm), while it is relatively easy to weld members made of a material such as stainless steel.

There is also published a technique of welding aluminum members together by performing nickel plating (see, for example, Japanese Examined Patent Application Publication No. 06-96199); however, the technique involves a problem that most part of the member is melted or greatly deformed due to heat in a case of, for example, welding thin or small constructional members of a hydrodynamic bearing assembly.

As described above, although aluminum has many favorable properties as a material of the hydrodynamic bearing assembly, such as lightweight, good processability, and resistance to oxidation and corrosion, it is difficult to have constructional members made of aluminum of a hydrodynamic bearing assembly fixed through laser welding and the like.

### SUMMARY OF THE INVENTION

The present invention has been made in view of the foregoing problems, and the present invention provides a method of manufacturing a bearing assembly capable of easily fixing constructional members of the bearing assembly integrally through irradiation of a converged energy beam on the constructional elements made of aluminum or an aluminum alloy.

According to a preferred embodiment of the present invention, there is provided a method of manufacturing a hydrodynamic bearing assembly including a stator and a rotor which is rotatable around the rotation axis relative to the stator. A rotor is rotatable about a rotational axis relative to the stator, and opposes to the stator via a gap defined therebetween. Lubricating is oil retained in the gap, and the gap includes a capillary seal portion at which the lubricating oil meets an outside air. A portion of the rotor or the stator defining the capillary seal portion of the gap is formed by joining a plurality of members at a joining portion. Hydrodynamic pressure is produced in the lubricant fluid filled in the gap between the rotor and the stator, to rotatably support the rotor relative to the stator. The method according to a preferred embodiment of the present invention, at least one of the plurality of members is plated. The plurality of members are arranged such that the plurality of members come in contact to each other at the joining portion, and the converged energy beam is applied to the joining portion to weld the plurality of members together. In this case, a thickness of a plating layer is less than 10 μm in total at the joining portion.

By the method according to the preferred embodiment of the present invention, the members made of aluminum, which have been considered difficult to be welded, can be welded together efficiently. Also, since the amount of plated metal to be mixed into the welded metal can be suppressed by setting the total thickness of plating to less than 10 μm, it becomes possible to prevent occurrence of damaging phenomena for reliability and a hermetic property of the welded portion, such as a hot crack. Further, because the plating thickness is set to less than 10 μm, it becomes possible to prevent relatively small elements or thin elements to be used in the hydrodynamic bearing assembly from being greatly deformed or melted by heat due to excessive absorption of the converged energy beam.

Other features, elements, processes, steps, characteristics and advantages of the present invention will become more apparent from the following detailed description of preferred embodiments of the present invention with reference to the attached drawings.

### BRIEF DESCRIPTION OF THE DRAWINGS

FIG. 1 is a cross-sectional view illustrating a spindle motor including a hydrodynamic bearing assembly according to a preferred embodiment of the present invention;

FIG. 2 is a flowchart schematically illustrating a method according to the embodiment of the present invention;

FIG. 3 is a process diagram according to the embodiment of the present invention;

FIG. 4A is a process diagram according to the embodiment of the present invention;

FIG. 4B is a partially enlarged view illustrating part of the spindle motor in the process according to the embodiment of the present invention;

FIG. 5 is a process diagram according to the embodiment of the present invention;

FIGS. 6A to 6D are enlarged views illustrating a joined portion of a sleeve and a seal element welded together under specific conditions;

FIG. 7A is a vertical cross-sectional view illustrating a hydrodynamic bearing assembly according to another embodiment of the present invention;

FIG. 7B is a vertical cross-sectional view illustrating a hydrodynamic bearing assembly according to still another embodiment of the present invention; and

FIG. 8 is a comparative graph illustrating amounts of change in axial gap due to difference in methods of fixing a sleeve and a seal element.

### DETAILED DESCRIPTION OF THE PREFERRED EMBODIMENTS

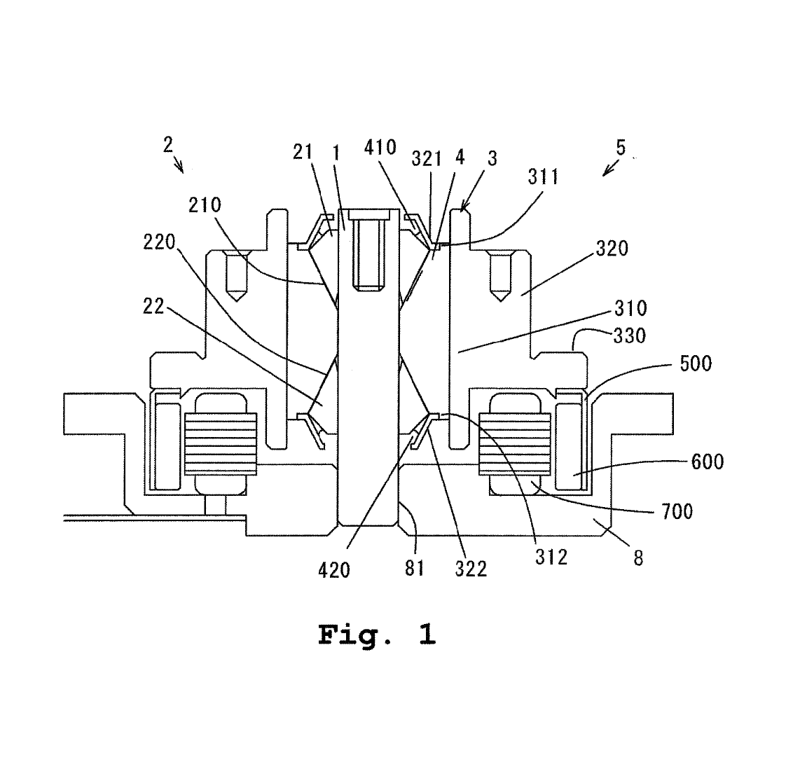

Preferred embodiments of the present invention will be described below with reference to FIGS. 1 to 8. It should be noted that in the description below, although the up and down direction of each figure is indicated as an up and down direction for convenience sake, it is not intended to define the actual direction in the state of being attached to a device. A direction parallel to the rotation axis is illustrated as a rotation axis direction (i.e., an axial direction), and a direction in which a radius extends from the rotation axis as the center is illustrated as a radial direction, in the description of the preferred embodiments of the prevent invention.

(Spindle Motor)

FIG. 1 is a vertical cross-sectional view illustrating a spindle motor including a hydrodynamic bearing assembly manufactured by a method according to a preferred embodiment of the present invention. The spindle motor includes a rotor unit 5 and a stator unit 2. The rotor unit 5 is supported in a manner rotatable about a center axis with respect to the stator unit 2. The rotor unit 5 includes a sleeve 4, a rotor hub 3 fixed to the sleeve 4, and an upper seal member 321 and a lower seal member 322 attached to upper and lower end portions of the sleeve 4 respectively. The stator unit 2 includes a shaft 1, and an upper bush 21 and a lower bush 22 attached to the shaft 1. The lower end of the shaft 1 is press fitted in an opening 81 and secured to a base plate 8.

The sleeve 4 is a substantially cylindrical member, and has an inner peripheral surface facing an outer peripheral surface of the shaft 1 via a minute gap defined therebetween. The sleeve 4 is provided with an upper recessed portion 210 and a lower recessed portion 220. The upper bush 21 and the lower bush 22 are fixed on an upper portion and a lower portion of the shaft 1 such that the upper bush 21 and the lower bush 22 are arranged at the upper recessed portion 210 and the lower recessed portion 220 respectively, to face the sleeve 4 with a minute gap in between. According to the present preferred embodiment of the present invention, the sleeve 4 is made of aluminum or an aluminum alloy.

On the upper and lower portions of the sleeve 4, the upper seal member 321 and the lower seal member 322 made of aluminum or an aluminum alloy are fixed to face the upper bush 21 and the lower bush 22 respectively, with the minute gap defined therebetween. An upper taper seal 410 (i.e., an capillary seal portion) is formed at the minute gap between the upper seal member 321 and the upper bush 21, and a lower taper seal 420 is formed at the minute gap between the lower seal member 322 and the lower bush 22. The upper taper seal 410 gradually increases in gap size along the axial upper direction, and the lower taper seal 420 gradually increases in gap along the axial lower direction.

The rotor hub 3 includes an inner cylindrical portion 310 and an outer cylindrical portion 320, both of which have a substantially cylindrical shape. The rotor hub 3 is fixed on the outer peripheral surface of the sleeve 4 by, for example, press fitting or adhesive bonding. A disk placing portion 330 is provided at a lower portion of the outer cylindrical portion 320. The disk placing portion 330 spreads radially outward from the outer cylindrical portion 320. A data storage disk such as a magnetic disk (not illustrated in drawing) is placed on the disk placing portion. A yoke 500 made of a magnetic material is fixed on the axially lower side of the disk placing portion 330, and a magnet 600 is secured on the inner peripheral surface of the yoke 500.

A stator 700 is fixed on the base plate 8 so as to face the magnet 600 with a gap defined therebetween in the radial direction.

Oil as a lubricant fluid is filled uninterruptedly in the minute gap between the sleeve 4 and the upper bush 21, the minute gap between the sleeve 4 and the lower bush 22, the minute gap between the sleeve 4 and the shaft 1, the minute gap between the upper seal member 321 and the upper bush 21, and the minute gap between the lower seal member 322 and the lower bush 22 (these minute gaps are collectively referred to as a “bearing gap” hereinafter). Air-liquid interfaces, which are boundary surfaces with ambient air, are formed on the oil retained in the minute gap between the upper bush 21 and the upper seal member 321 and the minute gap between the lower bush 22 and the lower seal member 322, i.e., at the upper taper seal 410 and the lower taper seal 420, respectively.

Dynamic pressure generating grooves are formed on each of the inner surfaces defining the upper recessed portion 210 and the lower recessed portion 220 of the sleeve 4, respectively. When the motor is rotated, hydrodynamic pressure occurs within the lubricant oil, so that the rotor unit 5 is held such that the sleeve 4 and the upper and lower bushes 21 and 22 do not come into contact with each other.

(Method of Manufacturing Hydrodynamic Bearing Assembly)

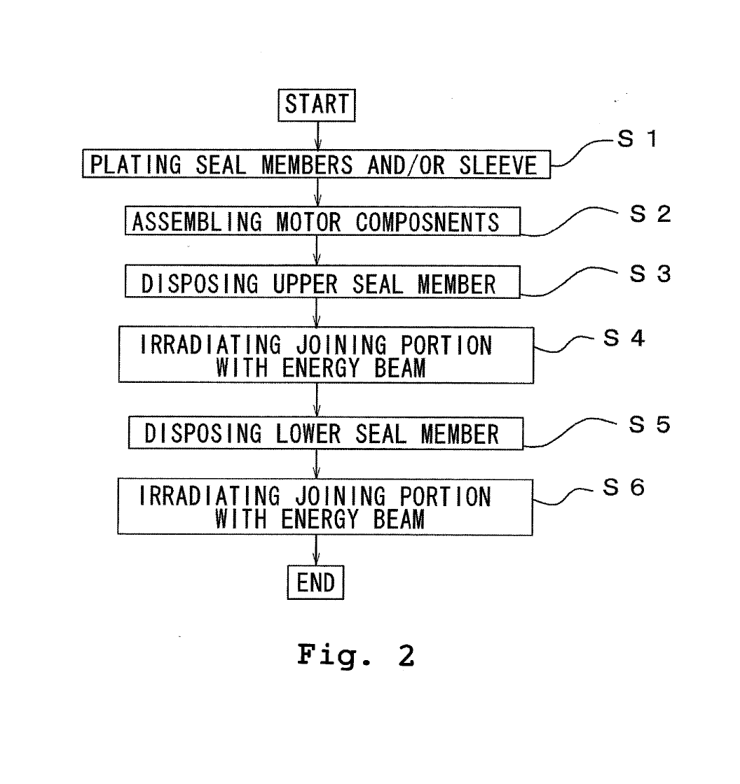

Referring to FIGS. 2 to 8, description will be given below on a method of manufacturing the hydrodynamic bearing assembly used in the spindle motor illustrated in FIG. 1. More specifically, detailed description will be made on a method of welding and fixing the sleeve 4 and the upper and lower seal members 321 and 322. It should be noted that the same method is applied for welding and fixing the lower seal member 322 and the sleeve 4 as that for the upper seal member 321 and the sleeve 4 unless otherwise specified. Further, the upper seal member 321 and the lower seal member 322 are collectively referred to as the “seal member” where description is given on the configuration common to these two seal members.

As illustrated in FIG. 2, the method of manufacturing the hydrodynamic bearing assembly according to the embodiment of the present invention includes the steps of plating the seal member made of aluminum or an aluminum alloy and/or the sleeve 4 made of aluminum or an aluminum alloy (step S1), assembling motor components including the shaft 1, the upper bush 21, the lower bush 22, the sleeve 4, and the rotor hub 3 (step S2), disposing the seal member on the sleeve 4 (steps S3 and S5), irradiating an joining portion of the seal member and the sleeve 4 with a converged energy beam such as YAG laser to perform welding (steps S4 and S6), and filling a lubricant fluid (not illustrated).

First, step S1 in FIG. 2 will be described. In step S1, nickel plating is performed on the seal member made of aluminum or an aluminum alloy and/or the sleeve 4 made of aluminum or an aluminum alloy. In the preferred embodiment of the present invention, nickel plating is performed only on the seal member; however, nickel plating may be performed on both the seal member and the sleeve 4. It is only necessary that the plating be performed on the area at which the converged energy beam is to be applied in the subsequent welding step which will be described later, and the plating need not be performed so as to cover the entire part of the members to be welded. Moreover, metals such as iron or platinum may be plated on the seal member and/or the sleeve 4, instead of nickel.

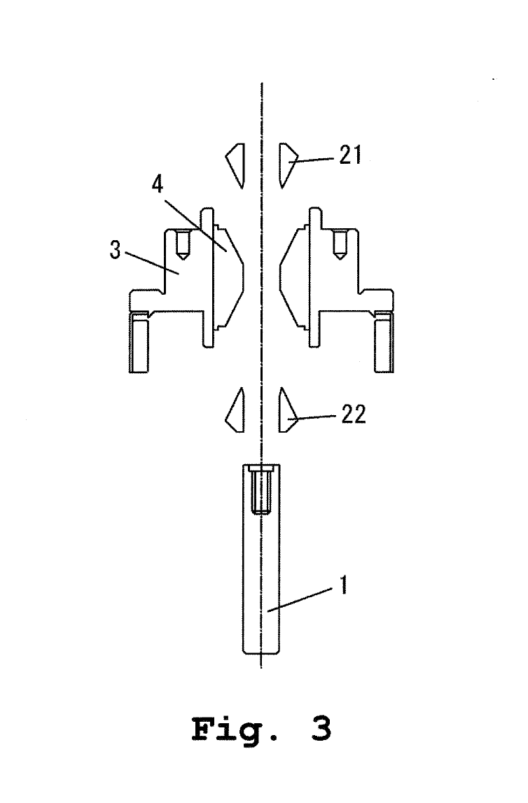

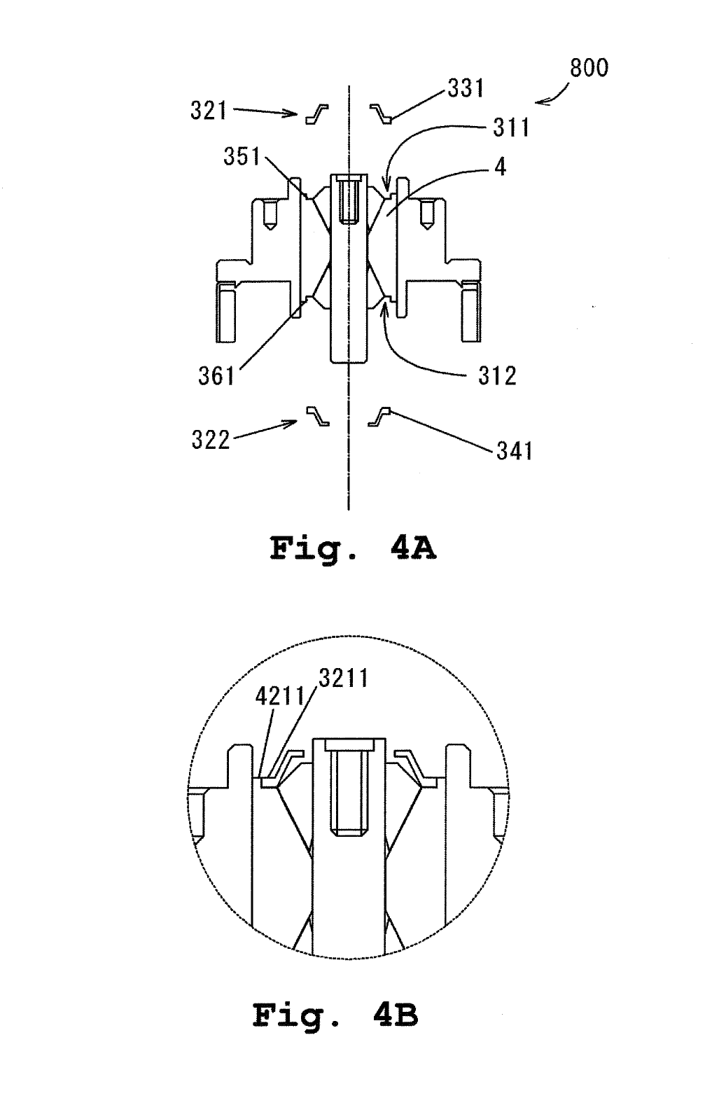

Step S2 in FIG. 2 will be described with reference to FIG. 3. First, the lower bush 22 is fixed at a lower portion of the shaft 1 by, e.g., press fitting or adhesive bonding. Then, the rotor unit 5 including the sleeve 4 and the rotor hub 3 fixed on the outer peripheral surface of the sleeve 4 is held such that the sleeve 4 opposes the lower bush 22 with a minute gap in between. Then, the upper bush 21 is fixed to the shaft 1 from above the sleeve 4 such that the upper bush 21 opposes the sleeve 4 with a minute gap in between. In this way, a motor component 800 (see FIG. 4A) can be obtained.

Step S3 will be described below with reference to FIGS. 4A and 4B. Provided on a radially inner portion of the upper end surface of the sleeve 4 in the motor component 800 is an upper step portion 311 defined by a cylindrical surface 351 (i.e., a contacting surface) extending axially downward from the upper end surface and a circular surface (i.e., a supporting surface) stretching radially inward from the axially lower end of the cylindrical surface 351, as illustrated in FIG. 4A. Similarly, provided on the lower end surface of the sleeve 4 is a lower step portion 312 defined by a cylindrical surface 361 (i.e., a contacting surface) extending axially upward from the lower end surface and a circular surface (i.e., a supporting surface) stretching radially inward from the axially upper end of the cylindrical surface 361. The upper seal member 321 is disposed on the upper step portion 311 with its side surface 331 meeting the cylindrical surface 351, as illustrated in FIG. 4B. The axial height of the cylindrical surface 351 is set such that an upper surface 3211 of the upper seal member 321 and the upper end surface 4211 of the sleeve 4 are aligned on substantially the same plane. Similarly, the axial height of the lower cylindrical surface 361 is set such that a lower surface of the lower seal member 322 and the lower end surface of the sleeve 4 are aligned on substantially the same plane.

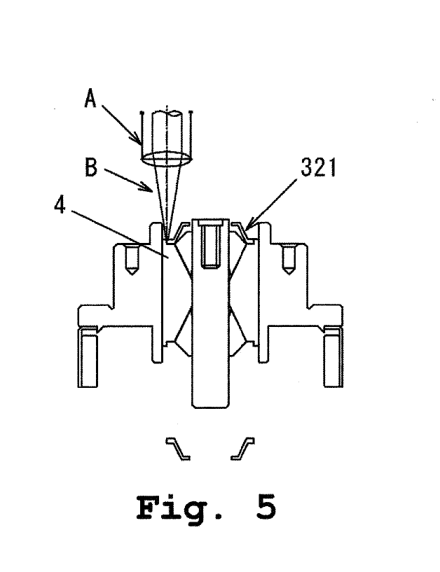

Step S4 will be described next. As illustrated in FIG. 5, a laser-welding machine A irradiates the joining portion of the sleeve 4 and the upper seal member 321 with a converged energy beam B to weld the sleeve 4 and the upper seal member 321 together. In the present embodiment, welding was performed using a laser-welding machine (HLD501 manufactured by TRUMPF GmbH) to apply a converged energy beam. Used as the converged energy beam was a continual beam of YAG laser having a wavelength of 1030 nm and a beam diameter of 0.3 mm. In an argon atmosphere, a laser source was fixed, and a laser beam was continuously applied at the joining portion while rotating the sleeve 4 and the upper seal member 321 to effect all-around welding. The flow rate of argon was 20 liters per minute, and the output power of the laser at the fade-out was 5 W. The seal member used in the present embodiment was 8.2 mm in diameter, and the weld length was 25.8 mm.

Generally, nickel is higher in absorptance of laser beams than aluminum. By performing nickel plating on the constructional member made of aluminum of the hydrodynamic bearing assembly, the absorptance of laser is raised, and thus welding can be carried out efficiently. There may be a case, however, in which just one of the members is strongly melted or a thermal deformation or a crack is generated therein, depending on conditions such as thickness of plating performed on either of the upper and lower seal members or the sleeve and output power of laser.

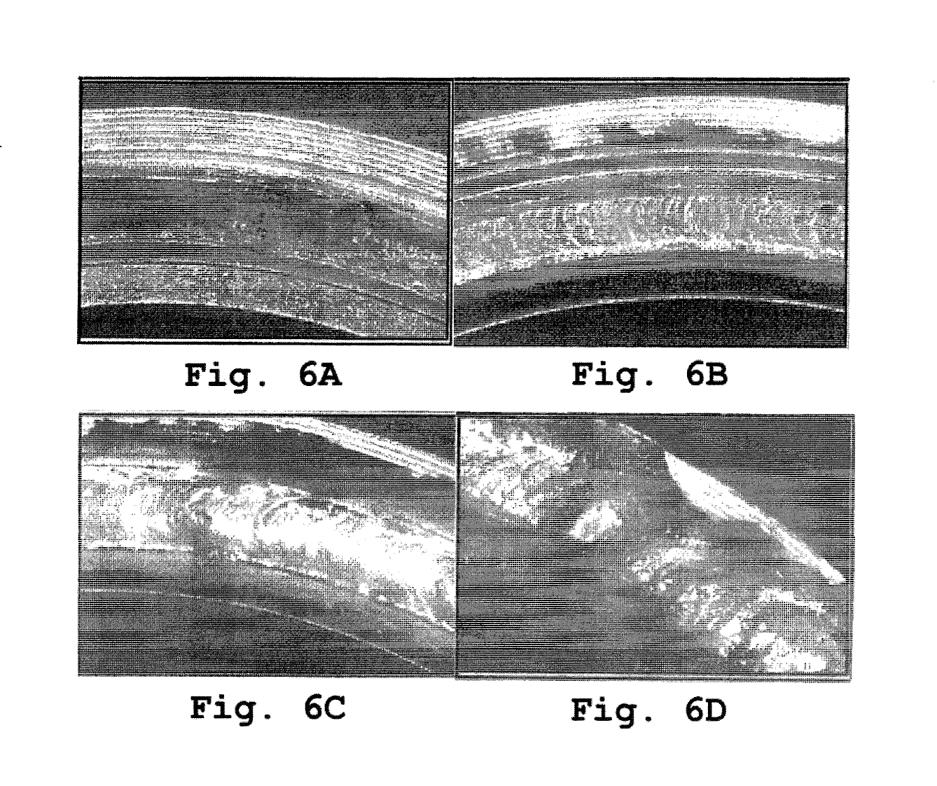

FIGS. 6A to 6D illustrate weld surfaces resulted from the welding of the sleeves 4 and the seal members on which nickel plating have been performed to different thicknesses. FIG. 6A illustrates a resultant weld surface of the sleeve 4 and the seal member in the case where the seal member was nickel-plated to a thickness of 5 μm, and a YAG laser beam with an output power of 400 W was applied at the joining portion of the seal member and the sleeve 4 to weld them together. FIG. 6B illustrates a resultant weld surface of the seal member that was nickel-plated to a surface of the seal member that was nickel-plated to a thickness of 20 μm and the sleeve 4, and FIG. 6D illustrates a resultant weld surface of the seal member that was nickel-plated to a thickness of 50 μm and the sleeve 4, respectively. The weld surfaces illustrated in FIGS. 6B to 6D were formed similarly to the case of FIG. 6A, i.e., by applying the YAG laser beam with the output power of 400 W to perform welding. As illustrated in FIGS. 5C and 6D, the members are strongly melted by heat in cases of nickel-plating thickness of 10 μm or more, which is not suitable in manufacturing a hydrodynamic bearing with which high machining accuracy is required.

Consequently, in the preferred embodiment of the present invention, the thickness of the nickel-plated layer formed between the seal member and the sleeve 4 is preferably less than 10 μm at the joining portion where the side surface of the seal member meets the sleeve 4 opposedly in the radial direction. When the plating thickness on the seal member is about 2 to about 5 μm, the seal member and the sleeve 4 can be welded together without weld cracks and leakage, plus the weld surface is formed flat and smooth; therefore, it is preferred that the seal member is nickel-plated to a thickness of about 2 to about 5 μm.

If plating can be performed uniformly on the abutting portion, the plating thickness may be less than 2 μm. This is because the reflectivity of light is determined almost solely by the quality of the material forming the surface. Once the surface is melted, the crystal structure of the metal is disturbed by the melting, and the light reflectivity is lowered. Hence, the welding area can continuously absorb the laser beam even in the absence of the plated metal. Accordingly, there is no need to provide a lower limit to the thickness of the plated layer so long as the plated layer can be uniformly formed on the surface of the member.

After completion of the welding of the upper seal member 321 and the sleeve 4, a side surface 341 of the lower seal member 322 is positioned so as to meet the cylindrical surface 361 of the lower step portion 312 provided on the lower side of the sleeve 4 (step S5). The axial thickness of the cylindrical surface 361 is set such that a lower surface of the lower seal member 322 and the lower end surface of the sleeve 4 are aligned on substantially the same plane. Then, a converged energy beam is applied at the joining portion of the sleeve 4 and the lower seal member 322 to perform welding (step S6).

In the present embodiment, although the lower seal member 322 and the sleeve 4 are welded together after the upper seal member 321 and the sleeve 4 are welded together, the present invention is not limited thereto. The lower seal member 322 and the sleeve 4 may be welded together first, or it is also possible to simultaneously weld both of the upper seal member 321 and the lower seal member 322 to the sleeve 4.

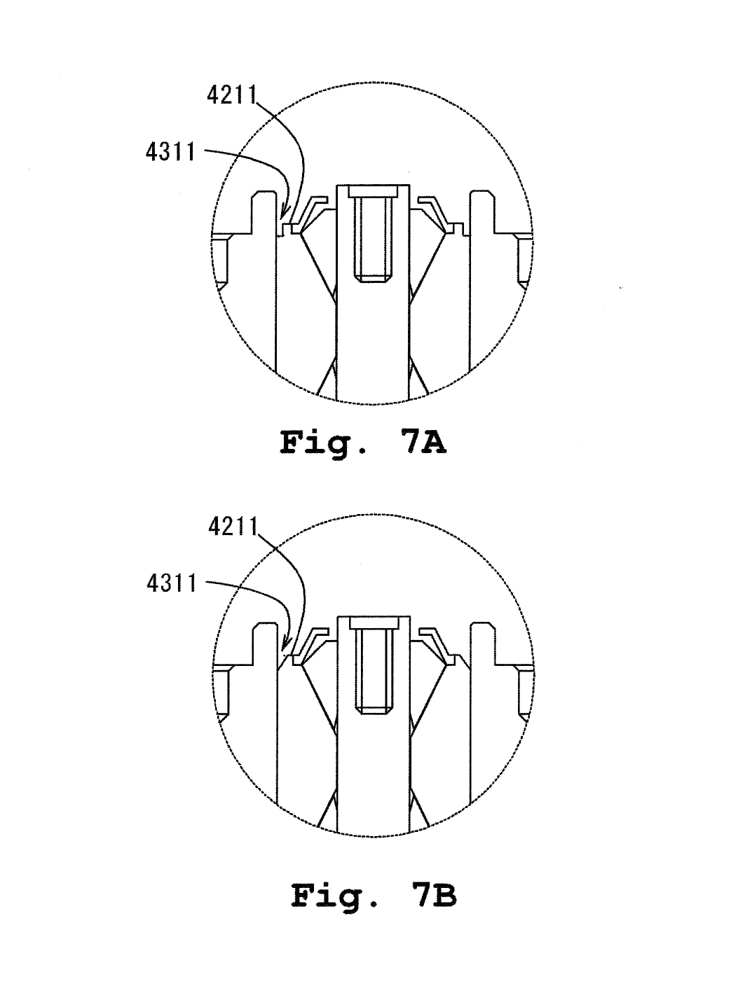

Moreover, as illustrated in FIGS. 7A and 7B, an annular dent 4311 may be formed along a portion radially outside of the portion where the sleeve 4 and the seal member abut on each other. The annular dent 4311 extends axially downward from the upper end surface 4211 of the sleeve. By providing the dent 4311, the axial gap in the hydrodynamic bearing assembly can be prevented from being changed due to deformation of the sleeve 4 during welding. Similarly, an annular dent may be provided on the lower end surface of the sleeve. FIG. 8 is a comparative graph showing amounts of change in the axial gap in the case of laser welding the seal member to the sleeve 4 with the annular dent 4311, and in the case of laser welding the seal member to the sleeve 4 without the annular dent. FIG. 8 also illustrates amounts of change in the axial gap in the case of fixing the seal member to the sleeve 4 made of aluminum by caulking, and in the case of laser welding the seal member to the sleeve 4 made of stainless steel. As apparent from the amounts of change in the axial gap in FIG. 8, the deformation can be suppressed in the cases where the annular dent 4311 is provided, to almost the same degree as in the case of welding the seal member to the sleeve made of stainless steel.

The foregoing detailed description is given to describe preferred embodiments of the present invention by way of example, and is not intended to limit the scope of the present invention. Various changes and modifications can be made herein without departing from the spirit of the present invention, and it should be understood that such changes and modifications are encompassed by the scope of the present invention.

In the preferred embodiments of the present invention, nickel plating is performed on either one of the sleeve 4 or the seal member, to a thickness of less than 10 μm. The nickel plating may be, however, performed on both the sleeve 4 and the seal member such that the total thickness of the plated layers between the sleeve 4 and the seal member results in less than 10 μm at the joining portion of these members.

Further, although the YAG laser beam having a wavelength of 1030 nm is used for welding in the preferred embodiments of the present invention, another suitable converged energy beam, such as CO₂ laser, may be employed for welding. Moreover, the laser beam may be either a pulse beam or a continual beam.

Further, although the irradiation of the laser beam is carried out in an argon atmosphere in the preferred embodiments of the present invention, the present invention is not limited thereto. The irradiation of laser beam may be carried out in an atmosphere of, for example, helium, neon, nitrogen, or hydrogen.

Further, the description has been given in detail on the welding of the seal member and the sleeve in a shaft-fixed type motor in the preferred embodiments of the present invention. The preferred embodiments of the present invention, however, may be applied to the welding of other members. The method according to the preferred embodiments of the present invention may be suitably applied to the joining of two or more members made of aluminum or aluminum alloy constructing a hydrodynamic bearing. For example, the rotor holder and the seal member may be welded and fixed together by the method according to the preferred embodiments of the present invention.

What is claimed is:

1. A method of manufacturing a hydrodynamic bearing assembly including a stator, a rotor which is rotatable about a rotational axis relative to the stator and opposing to the stator via a gap defined therebetween, and a lubricating oil retained in the gap, the gap includes a capillary seal portion at which the lubricating oil meets an outside air, a portion of the rotor or the stator defining the capillary seal portion of the gap is formed by joining a plurality of members at a joining portion, comprising steps of:
(a) plating at least one of the plurality of members;
(b) arranging the plurality of members such that the plurality of members come in contact to each other at the joining portion; and
(c) irradiating a converged energy beam to the joining portion to weld the plurality of members together,
wherein a thickness of a plating layer is less than 10 μm in total at the joining portion.

2. A method as set forth in claim 1, wherein at least one of the plurality of member includes an contacting surface extending in an axial direction to which at least one of the other of the plurality of members comes in contact and a supporting surface to which the at least one of the other of the plurality of members comes in contact to axially position the at least one of the other of the plurality of members on the at least one of the plurality of members.

3. The method as set forth in claim 1, wherein:
the stator includes a shaft and a bush attached to the shaft;
the rotor includes a sleeve having a radially inner surface opposing the shaft via the gap defined therebetween, a rotor hub attached to a radially outer surface of the sleeve, and a seal member arranged to oppose the bush via a portion of the gap defining the capillary seal portion; and
the plurality of members are the seal member and the sleeve.

4. The method as set forth in claim 3, wherein in the step (a), a portion of the seal member which comes into contact to the sleeve is plated.

5. The method as set forth in claim 3, wherein:
the seal member has a circular outer shape;
the sleeve includes a circular concave on an axially end portion thereof, defined with the abutting surface and the supporting surface; and
in the step (b), the seal member is arranged on the supporting surface of the sleeve while a radially outer surface of the seal member comes in contact with the abutting surface of the sleeve.

6. The method as set forth in claim 5, wherein a length of the abutting surface along an axial direction is substantially the same or greater than a thickness of the seal member along the axial direction.

7. The method as set forth in claim 5, wherein a sleeve includes a dent extending in the axial direction and arranged radially outside of the contacting surface.

8. The method as set forth in claim 1, wherein:
the stator includes a shaft and a bush attached to the shaft;
the rotor includes a sleeve having a radially inner surface opposing the shaft via a gap defined therebetween, a rotor hub attached to a radially outer surface of the sleeve, and a seal member arranged to oppose the bush via a minute gap defined therebetween;
the lubricating oil meets an air in the minute gap thereby defining a capillary seal portion; and
the plurality of members are the seal member and the rotor hub.

9. The method as set forth in claim 8, wherein in the step (a), a portion of the seal member which comes into contact to the rotor hub is plated.

10. The method as set forth in claim 8, wherein:
the seal member has a circular outer shape;
the rotor hub includes a circular concave on an axially end portion thereof, defined with the abutting surface and the supporting surface; and
in the step (b), the seal member is arranged in the circular concave portion while a radially outer surface of the seal member comes in contact with the abutting surface of the rotor hub.

11. The method as set forth in claim 10, wherein a length of the abutting surface along an axial direction is substantially the same or greater than a thickness of the seal member along the axial direction.

12. The method as set forth in claim 10, wherein a rotor hub includes a dent extending in the axial direction and arranged radially outside of the contacting surface.

13. The method as set forth in claim 1, wherein the converged energy beam irradiated to the joining portion of the plurality of members is a YAG laser beam.

14. The method as set forth in claim 1, wherein in the step (a), one or more selected from a group including Nickel, Iron, and Platinum is used for plating at least one of the plurality of members.

15. A spindle motor comprising the hydrodynamic bearing assembly manufactured by the method as set forth in claim 1.

16. A storage disk drive comprising the spindle motor as set forth in claim 13.
